(19) United States
(12) Patent Application Publication
(10) Pub. No.: US 2021/0007546 A1
(43) Pub. Date: Jan. 14, 2021

(54) Food Vessel Heater

(71) Applicant: Magellan Home-Goods, Ltd., Blaine, WA (US)

(72) Inventor: Andre Dean Cloutier, Blaine, WA (US)

(21) Appl. No.: 16/925,275

(22) Filed: Jul. 9, 2020

Related U.S. Application Data
(60) Provisional application No. 62/953,112, filed on Dec. 23, 2019.
(60) Provisional application No. 62/872,436, filed on Jul. 10, 2019.

(51) Int. Cl. A47J 36/24

(52) U.S. Cl. CPC A47J 36/2405

(57) ABSTRACT

A water actuated food vessel heater comprising: an outer surface resting upon a support surface and configured to directly support the bottom surface of a chafing pan assembly; an upper rim comprising an elastic material; a lower rim comprising an elastic material; an inner bowl configured to hold a volume of water; and a plurality of vent grooves in an upper edge of the chafing heater.

### RELATED APPLICATIONS

This application claims priority of U.S. Provisional Patent Application Ser. No. 62/872,436 filed on Jul. 10, 2019, and U.S. Provisional Patent Application Ser. No. 62/953,112 filed on Dec. 23, 2019, each incorporated herein by reference.

### BACKGROUND OF THE DISCLOSURE

### Field of the Disclosure

This disclosure relates to the field of food vessel heaters configured to rest upon a support surface and support a cooking pan or chafing dish. The heater comprising a heat source configured to supply heat to the cooking pan or chafing dish.

### BRIEF SUMMARY OF THE DISCLOSURE

Disclosed herein is a food vessel heater comprising: an outer surface resting upon a support surface such as a table, counter, or food prep area. In one example the outer surface of the food vessel heater is configured to directly support the bottom surface of a food vessel. In one example the food vessel heater comprises an upper rim comprising an elastic material and/or non-slip surface. In one example the chafing heater includes a lower rim comprising an elastic material and/or non-slip surface. The chafing heater optionally comprising an inner bowl configured to hold a volume of water; and optionally a plurality of vent grooves in an upper edge of the food vessel heater. In one example the heat source is a water actuated heat source.

A food vessel heater in one example comprises an outer surface resting upon a support surface and an upper rim configured to directly support a cooking pan resting thereupon. The food vessel heater comprising an inner bowl configured to hold a volume of water; plurality of vent grooves in the upper rim of the food vessel heater; a water actuated heat source configured to be placed in the inner bowl and chemically react with the water to form heat and steam; and the steam in direct contact with the cooking pan.

The food vessel heater may be arranged wherein the upper rim comprises an elastic or non-skid material in direct contact with the cooking pan.

The food vessel heater may further comprise a lower rim comprising an elastic or non-skid material.

The food vessel heater may be arranged wherein the upper rim is formed via overmolding.

The food vessel heater may further comprise a lower rim comprising an elastic or non-skid material.

The food vessel heater may be arranged wherein the lower rim is formed via overmolding.

### BRIEF DESCRIPTION OF THE SEVERAL VIEWS OF THE DRAWINGS

FIG. 1 is a top perspective view of one example of the disclosed food vessel heater.

FIG. 2 is a side cutaway view of the example shown in FIG. 1.

FIG. 3 is a top view of the example shown in FIG. 1.

FIG. 4 is a bottom view of the example shown in FIG. 1.

FIG. 5 is a side view of the example shown in FIG. 1.

FIG. 6 is a top perspective view of an ovaloid version of the example shown in FIG. 1.

FIG. 7 is a top view of the example shown in FIG. 6.

FIG. 8 is a bottom view of the example shown in FIG. 6.

FIG. 9 is a side view of the example shown in FIG. 6, the opposing side view being a mirror image thereof.

FIG. 10 is a rear view of the example shown in FIG. 6, the opposing front view being a mirror image thereof.

FIG. 11 is a side perspective view of the disclosed apparatus in use with a prior art chafing dish assembly.

FIG. 12 is a perspective view of another example of the disclosed food vessel heater.

FIG. 13 is a top view of the example shown in FIG. 12.

FIG. 14 is a left side view of the example shown in FIG. 12.

FIG. 15 is a front view of the example shown in FIG. 12.

FIG. 16 is a right-side exploded view of the example shown in FIG. 12.

FIG. 17 is a rear view of the example shown in FIG. 12.

FIG. 18 is a bottom view of the example shown in fig.

FIG. 19 is an environmental view of the example shown in FIG. 12 being prepared for use.

FIG. 20 is an environmental view of the example shown in FIG. 12 being prepared for use.

FIG. 21 is an environmental view of the example shown in FIG. 12 in use.

FIG. 22 is an environmental view of the example shown in FIG. 12 in use.

### DETAILED DESCRIPTION OF THE DISCLOSURE

In the field of cooking/warming/serving/chafing pans such as disclosed in U.S. patent application Ser. No. 13/035,931 (incorporated herein by reference); a chafing pan is placed in a support frame and thus the chafing pan is held above a heat source, generally a flame from an alcohol-based fuel. The frame suspends the chafing pan above the heat source such that the heat source is well below the chafing pan, does not directly contact the container of the heat source, and the heat is more easily distributed across the bottom of the chafing pan.

Chafing pans with heaters in many different versions are well known in the art for the heating, warming, cooking, and serving of food items. These chafing pans and chafing pan assemblies commonly use a heat source such as a combustion reaction (flame) or electric heat source and a separate frame which supports the chafing pan above the heat source. Disclosed herein is an exemplary combined frame and heat source container, removing the need for separate components. The combined device increasing thermal efficiency by increasing heat transfer to a cooking pan in that the upper edge of the heat source container is in direct and nearly continuous contact with the cooking pan, reducing storage space requirements, increasing protection to the cooking pan surface and increasing aesthetics. Also disclosed herein is a method to heat a cooking pan and food therein without addition of any flame or electric source, including a water activated heat source places into the disclosed food vessel heater 20.

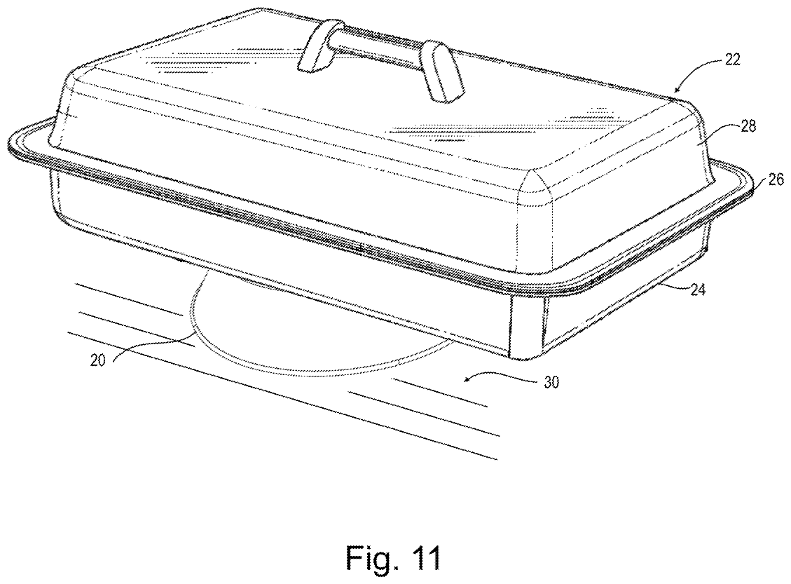

Cooking pans and other food vessel are widely used for keeping food warm, typically in connection with buffet-style food service. FIG. 11 for example shows a conventional chafing dish assembly 22, which in this example includes a water pan 24, a chafing dish 26 fitted with the water pan 24, a lid 28. The chafing dish assembly 22 of this example resting upon a heat source or chafing heater 20 novel to this disclosure. To use the chafing dish assembly 22 to keep food warm comprises several steps, in no particular order, the water pan 24 may be partially filled with water or other fluid or heat dissipating component, the chafing heater(s) 20 is placed on a support surface 30 such as a table, food prep surface, cart, or countertop. The heat source 32 is activated by chemical reaction, ignition of a flammable source, electrical activation of an electric component, etc. to produce heat within the chafing heater 20. The water pan 24 is placed on the chafing heater 20 to heat the water (if present) in the water pan 24. Food is placed inside the chafing dish 26, and the chafing dish 26 is inserted into the water pan 24 (if present). When used, the water in the water pan 24 is used as a medium to transfer heat (commonly as steam) from the chafing heater to the food within the chafing dish 26. The lid 22 may be used to cover the chafing dish 26, thereby maintaining moisture, smells, and heat within the chafing dish 26.

One particular advantage of the disclosed food vessel heater 20 in one example is that steam is a product of the chemical reaction within the food vessel heater, and thus the water pan 24 is not needed. The chafing dish 26 or cooking pan 122 may be placed directly above the heat source and the resultant steam is in direct contact with the chafing dish 26 or cooking pan 122.

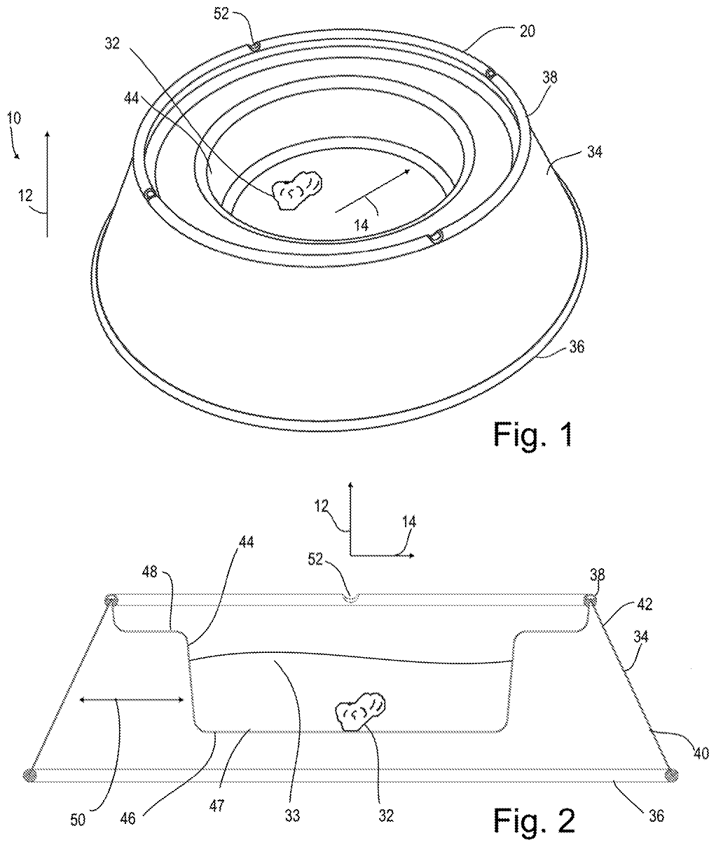

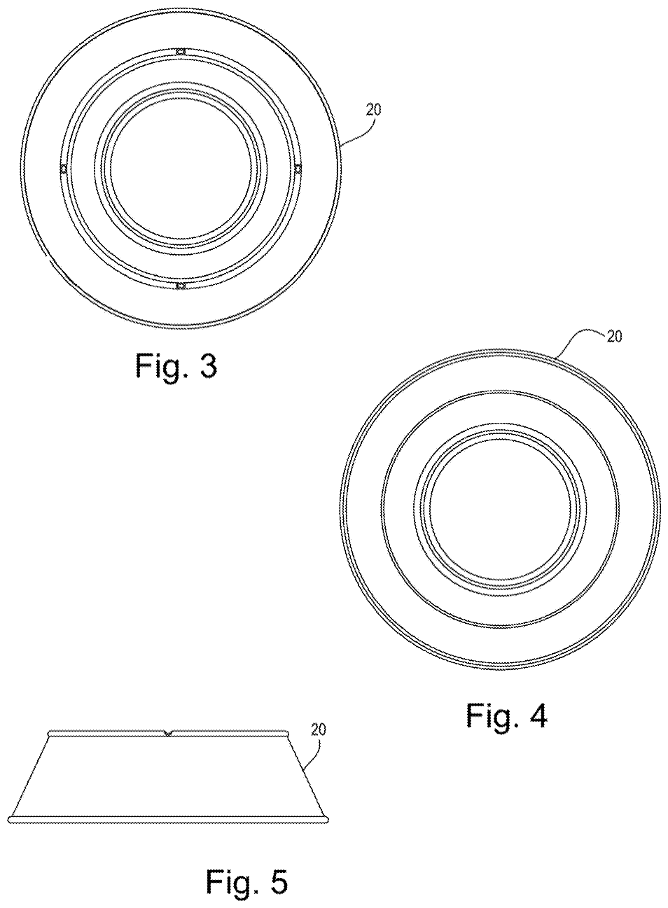

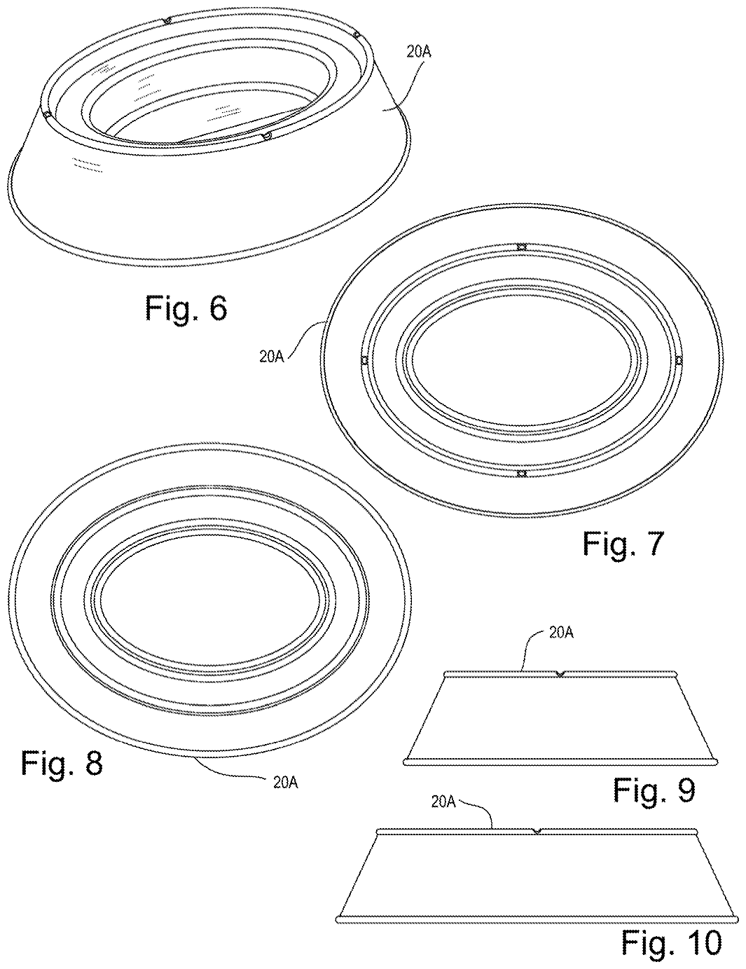

Looking to FIG. 1, one example of the chafing heater 20 is shown. This example comprising a structure forming an outer surface 34 of the chafing heater 20. The outer surface 34 extending from a lower rim 36 to an upper rim 38. Where this outer surface 34 may be seen by customers, clients, and others in use in some applications, it may be desired to add decorative elements to this outer surface 34.

In one example, where the chafing dish 26 or cooking pan 122 rests directly on the chafing heater 20 and is supported thereby, including any food therein, it may be desired that the chafing heater 20 be made of metal or similar rigid structure. In examples where the outer surface 34 extends from the support surface 30 to the chafing dish assembly 22, the outer surface 34 may be made sufficiently strong to support the weight of the chafing dish 26 or cooking pan 122 including the lid 28, as well as any food item(s) in the chafing dish 26 or cooking pan 122.

To maintain the chafing heater in position on the surface support 30, the lower rim 36 may comprise an elastic or non-slip component 40 such as rubber, soft plastic, silicone, and equivalents. Elastic herein defined as a structure capable of returning to its original length, shape, etc., after being stretched, deformed, compressed, or expanded. Non-skid indicating a material that with the frictional force expressed as

Ff=μN (1)

where

Ff=frictional force (N, Ib)

μ=static (μs) or kinetic (μk) frictional coefficient

N=normal force between the surfaces (N, Ib)

Where the static coefficient of friction between the lower rim 36 and the support surface is greater than 0.6.

In one example this component 40 also provides a thermal barrier between the outer surface 34 and the support surface 30. This elastic or non-skid component 40 may be overmolded onto the outer surface 34. Overmolding in one example is a molding process that is used for projects with complex final molded component designs. In one example, a first component is formed out of one material and then transferred to a second mold. In this example the outer surface 34 or other rigid component of the chafing heater 20 is formed, then this rigid component is placed in a mold and the lower rim 36 is formed by molding onto the rigid component.

To maintain the chafing dish assembly in position on the chafing heater 20, the upper rim 38 may similarly comprise an elastic or non-skid component 42 such as rubber, soft plastic, silicone, and equivalents. In one example this component 42 also provides a thermal between the outer surface 34 and the chafing dish assembly 22 reducing hot spots inside the chafing dish assembly 22. This elastic component 42 may be also be overmolded onto the outer surface 34. In this example the outer surface 34 or other rigid component of the chafing heater 20 is formed, then this rigid component is placed in a mold and the upper rim 38 is formed by molding onto the rigid component. This overmolding step may be simultaneous with overmolding of the lower rim 36.

In one example, an inner surface 44 of the chafing heater 20 forms a watertight inner bowl 46 having an upper edge 38 in direct contact with the chafing dish 26 or cooking pan 122. In examples using a water activated heat source 32, (quicklime being one example), this watertight bowl allows the inner bowl to contain water 33 into which is placed the water activated heat source. Once the activated heat source 32 is actively chemically reacting, heat and vapor (steam) 156 will be released. Generally, this vapor 156 is substantially steam thus is food safe. For best thermal conductivity to the chafing dish assembly 22 a large area of the chafing heater 20 (area bounded by the upper rim 38) is desired, with a slight positive pressure so that the heat is most efficiently transferred to the chafing dish assembly 22. Thus, the grooves 52 or 152 are sized, positioned, and shaped to allow vapors to exit under slight pressure, and pressure not to build up to a point where the chafing assembly 20 may be lifted off the chafing heater 20. In many prior known applications, using a flame heat source, it is desired to allow a larger volume of the exhaust gasses to escape, allowing oxygen to enter the fuel source, so that combustion is most efficient.

In one example, it is desired to have an inner bowl 46 with a relatively small volume (small radial 14 area of the bottom of the inner bowl 46), and a large cross-sectional upper area to enhance thermal conductivity to the chafing dish assembly 22. Thus, the inner bowl may form a radial 14 extension 48 increasing the upper area of the inner bowl 46 adjacent the chafing dish assembly 22 with a smaller lower inner surface 47.

In one example, the inner bowl 46 is formed of a rigid, thermally resistant material. In one example the inner bowl 46 is formed of the same material as the outer surface 34. This rigid material may be metal, plastic, glass, etc.

In one example, a void 50 is defined by the inner bowl 46, the outer surface 34, and the lower rim 36. In one example, this void 50 may be filled with a thermally resistant material such as expanded foam, silicone, etc. for increased thermal insulation, increased support of the chafing dish assembly. In another example, the void 50 is sealed, and may comprise a vacuum further increasing thermal isolation between the inner bowl 46, the outer surface 34.

Often when actuated, the heat source 32 produces steam or vapors 156, increases air pressure in the inner bowl 46, and significant expansion of any air within the inner bowl 46. The vent grooves 52 in the upper rim 38 or directly there below allow for release of these vapors 156. These vent groves sized, shaped, and positioned to provide maximum heat conductivity and structural support to the chafing heater 20 while allowing a sufficient amount of vapors 156 to escape. In one example, these vent grooves 52, 152 extend less than ½ the circumference of the upper rim 38, 138. In another example these vent grooves extend less than ⅛ the height of the food vessel heater 20, 120.

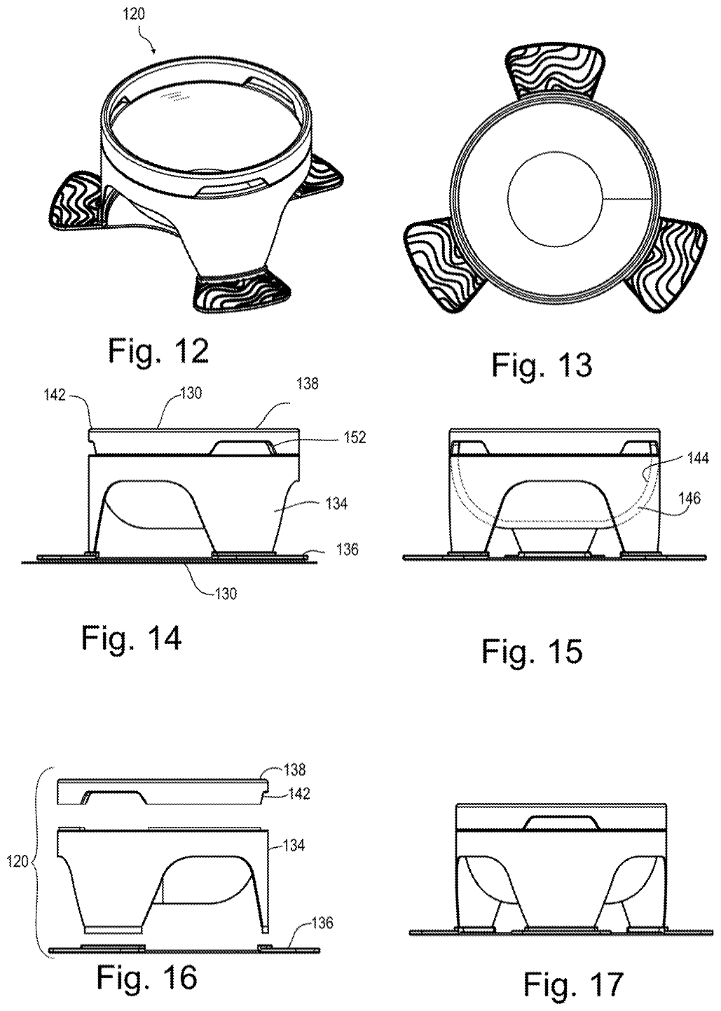

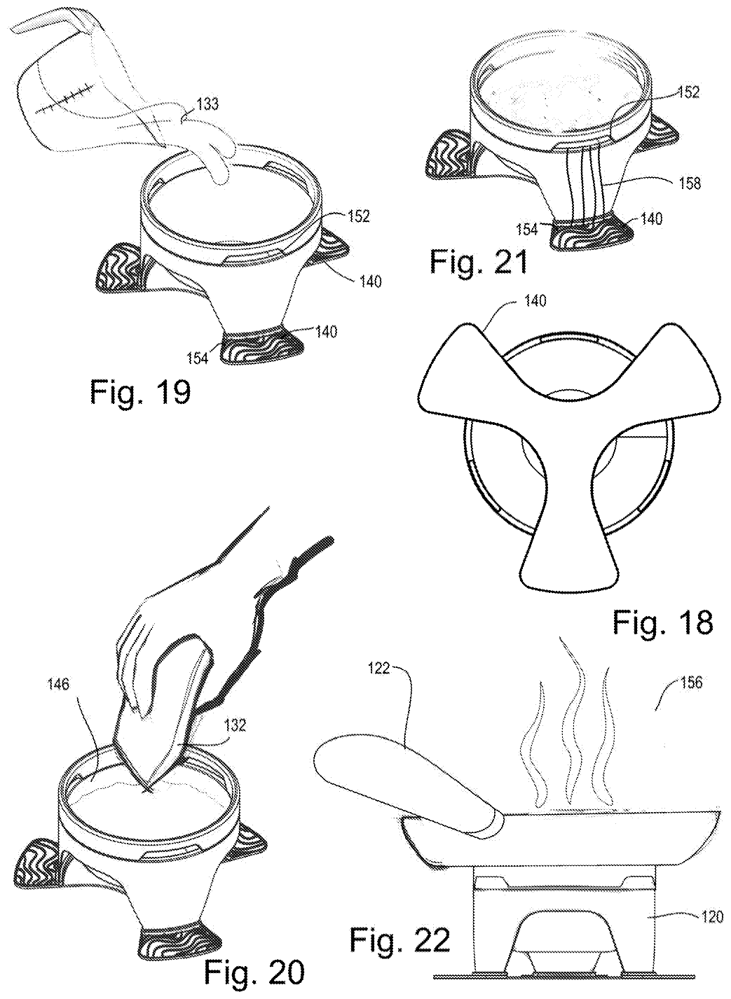

Looking to FIG. 12-FIG. 22 is shown a second example of a chafing assembly 120. Components of the second example chafing assembly 120 may be combined with components of the first example chafing assembly 20. Functionally equivalent elements and components of the second example 120 are labeled with a numeral “1” prefix compared to the first example. E.G. the chafing heater 120 of the second example compared to the chafing heater 20 of the first example.

Looking now to FIG. 12-22, a second example of the chafing heater 120 is shown. This example comprising a structure forming an outer surface 134 of the chafing heater 120. The outer surface 134 extending from a lower rim 136 to an upper rim 138. Where this outer surface 134 may be seen by customers, clients, and others in use in some applications, it may be desired to add decorative elements to this outer surface 134.

In one example, where the chafing dish 26 or cooking pan 122 rests directly on the chafing heater 120 and is supported thereby it may be desired that the chafing heater 120 be made of metal or similar rigid structure. In examples where the outer surface 134 extends from the support surface 130 to the chafing dish 26 or cooking pan 122, the outer surface 134 may be made sufficiently strong to support the weight of the chafing dish assembly 122 including any food item(s) in the chafing dish 26 or cooking pan 122.

To maintain the chafing heater 120 in position on the surface support 130, the lower rim 136 may comprise an elastic or non-skid component 140 such as rubber, soft plastic, silicone, and equivalents. In one example, this non-skid component 140 is removable from the outer surface 134 to be stored, replaced, and cleaned separately. In the example shown, this non-skid component 140 comprises extensions 154 projecting radially 14 outward beneath the vent groove(s) 152. These extensions 154 thus capture any condensate from the outer surface 134. In one example, the extensions 154 are positioned vertically below the vent grooves 152 so as to capture any condensate 158 dripping from the chafing dish 26, cooking pan 122 or chafing heater 120.

Elastic herein defined as a structure capable of returning to its original length, shape, etc., after being stretched, deformed, compressed, or expanded. In one example this component 140 may also provide a thermal and fluid barrier between the outer surface 134 and the support surface 130. This elastic component 140 may be overmolded onto the outer surface 134, adhered thereto, or pressed thereon. Overmolding in one example is a molding process that is used for projects with complex final molded component designs. In one example, a first component is formed out of one material and then transferred to a second mold. In this example the outer surface 134 or other rigid component of the chafing heater 120 is formed, then this rigid component is placed in a mold and the lower rim 136 is formed by molding onto the rigid component.

To maintain the chafing dish assembly 122 in position on the chafing heater 120, the upper rim 138 may similarly comprise an optionally removable elastic component 142 such as rubber, soft plastic, silicone, and equivalents. In one example this component 142 also provides a thermal and fluid barrier between the outer surface 134 and the chafing dish assembly 122 reducing hot spots inside the chafing dish assembly 122. This elastic component 142 may be also be overmolded onto the outer surface 34, adhered thereto, or press fit thereto as shown in FIG. 16. In this example the outer surface 134 or other rigid component of the chafing heater 120 is formed, then this rigid component is placed in a mold and the upper rim 138 is formed by molding onto the rigid component. This overmolding step may be simultaneous with overmolding of the lower rim 136.

In one example, an inner surface 144 of the chafing heater 20 forms a watertight inner bowl 146. In examples using a water activated heat source 132, (quicklime being one example), this allows the inner bowl 146 to contain water 133. The water activated heat source 132 is placed into the water 133 and quickly begins a highly exothermic chemical reaction. Once the activated heat source 132 is chemically reacting, heat and water vapor 156 will be released upward to the chafing dish 26 or cooking pan 122. Generally, this vapor 156 is food safe, and for best thermal conductivity to the chafing dish 26 or cooking pan 122 a large area of the chafing heater 120 (area bounded by the upper rim 138) is desired. Again, it may be desired to contain the vapors 156 with a slight positive pressure so that the heat is most efficiently transferred to the chafing dish 26 or cooking pan 122. Thus, the vent grooves 152 are sized, positioned, and shaped to allow vapor 156 to exit, and pressure not to build up to a point where the chafing assembly 120 is lifted off of the chafing heater 20. In one example, these vent grooves 52, 152 extend less than ½ the circumference of the upper rim 38, 138. In another example these vent grooves extend less than ⅛ the height of the food vessel heater 20, 120. In many prior known applications, using a flame heat source, it is desired to allow a larger volume of the exhaust gasses to escape, allowing oxygen to enter the fuel source, so that combustion can continue efficiently.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept. The invention illustratively disclosed herein suitably may be practiced in the absence of any element which is not specifically disclosed herein.

1. A food vessel heater (120) comprising an outer surface (134) resting upon a support surface (130) and an upper rim (138) configured to directly support a cooking pan (122) resting thereupon;
the food vessel heater (120) comprising an inner bowl (144) configured to hold a volume of water (133);
a plurality of vent grooves (152) in the upper rim (138) of the food vessel heater (120);
a water actuated heat source (132) configured to be placed in the inner bowl (144) and chemically react with the water (133) to form heat and steam (156); and
the steam (156) in direct contact with the cooking pan (122).

2. The food vessel heater (120) as recited in claim 1 wherein the upper rim (138) comprises an elastic or non-skid material (142) in direct contact with the cooking pan (122).

3. The food vessel heater (120) as recited in claim 2 further comprising a lower rim (136) comprising an elastic or non-skid material.

4. The food vessel heater (120) as recited in claim 2 wherein the upper rim (138) is formed via overmolding.

5. The food vessel heater (120) as recited in claim 1 further comprising a lower rim (136) comprising an elastic or non-skid material.

6. The food vessel heater (120) as recited in claim 5 wherein the lower rim (136) is formed via overmolding.
